(19) United States
(12) Patent Application Publication
(10) Pub. No.: US 2011/0297129 A1
(43) Pub. Date: Dec. 8, 2011

(54) Internal combustion engine and charge fluid cooler

(76) Inventor: Michael Hartmann, Salem-Mimmenhausen (DE)

(21) Appl. No.: 13/134,634

(22) Filed: Jun. 6, 2011

(30) Foreign Application Priority Data
Jun. 3, 2010 (DE) 10 2010 029 691.0

(51) Int. Cl. F02B 29/04

(52) U.S. Cl. 123/540

(57) ABSTRACT

In an internal combustion engine with a motor block and a charge fluid cooler mounted thereon wherein the motor block comprises a cylinder block with a cylinder head mounted thereon, the charge fluid cooler is attached to the cylinder head via an outlet manifold flange and a cylinder head flange which are joined by at least one first screw connection via a spacer member arranged at a side of a charge fluid inlet passage extending through the flanges and at least one second screw connection is provided for attaching the charge fluid cooler to the cylinder block via a second screw connection providing for a partially rigid and a partially elastic support.

### BACKGROUND OF THE INVENTION

The invention relates to an internal combustion engine with an engine block and a charge fluid cooler attached to the motor block wherein the motor block comprises a cylinder block and a cylinder head disposed on the cylinder block and wherein the charge fluid cooler has a cooler block and a cooler housing with an outlet manifold and the cooler housing has a first stop structure for mounting the charge fluid cooler to the cylinder head by means of a first screw connection. The first stop structure has an opening and the outlet manifold flange has a connecting surface for forming a flange connection with a cylinder head-side flange connecting surface, wherein the flange connection between the outlet manifold and the cylinder head is established by the first screw connection at the side of a cross-section of a charge fluid inlet channel, and the cooler housing comprises a second stop structure for mounting the charge air cooler by means of a second screw connection to the cylinder block whereby a support is provided for the charge fluid cooler at the second screw connection.

The invention also relates to a charge air cooler which is suitable for mounting to an internal combustion engine with a cylinder block and a cylinder head.

Such an internal combustion engine is disclosed in Applicants' DE 10 2007 045 196 A1 where an engine block and a cooler in the form of a charge air cooler assembly is shown mounted to the engine block. The embodiment as shown therein in FIG. 1 includes a cooler which is fixed to the cylinder head by two first screw connection and to the cylinder block by three second screw connection to be fixed in all directions. A bolt of the first screw connection at the cylinder head passes through a support opening extending fully through the cooler outlet housing wherein the support opening is formed integrally with the cooler outlet housing during casting thereof. On an outlet manifold-side flange connecting surface facing the cylinder head side flange connecting surface the opening has a connecting surface area which forms a part of the outlet manifold flange connecting surface area of the cooler outlet housing. The second screw connection is provided at a lower cooler outlet housing part in connection with a support structure fixing the cooler outlet part in all directions. Altogether the housing comprises a cooler inlet housing part, a cooler block housing part for accommodating a cooler block and a cooler outlet housing part with an exhaust manifold. The cooler inlet housing part, the cooler block housing part and the cooler outlet housing part are each joined by means of a form-fitting connecting structure for forming the cooler housing. The connecting joints extend along the circumference of the housing part.

It has been found during extended operation of such an internal combustion engine that the mounting of the cooler to the engine block needs to be improved. It has been found in particular that, with the fixed installation of the cooler on the engine block by means of the above-mentioned first and second screw connections which fix the housing in all directions, the form-fitting connections between the housing parts of the charge air cooler are overly stressed over a long period of operation. This can result in cooler housing damages which detrimentally affect the functioning of the charge fluid cooler.

It is therefore the object of the present invention to provide an improved internal combustion engine with an improved charge fluid cooler. In particular, the mounting of the charge fluid cooler to the engine block is to be improved. That is, the mounting should be improved so that vibrations and relative movements between the charge fluid cooler at one hand, and the engine block on the other hand as well as material tensions—caused detrimental effects to the connecting joints of the cooler housing are reduced. In particular, an improved attachment of the charge fluid cooler to the motor block should be of a design permitting replacement of earlier designs already used in existing internal combustion engines or permitting replacement with only simply measures for an improvement of a use of charge fluid coolers on motor blocks.

### SUMMARY OF THE INVENTION

The object is fulfilled with respect to the internal combustion engine by means of an internal combustion engine of the type referred to above by providing an opening on the cooler housing provided with an accommodation space with respect to the manifold-side flange surface, wherein a length of the space is greater than a length of the opening and the first screw connection extends through a spacer sleeve which is disposed in the accommodation space and takes up the load and wherein the flange connection is formed with a relief gap formed between the manifold-side and the cylinder head-side flange connecting areas and wherein the support structure provided by the second stop structure comprises a partially fixed and partially elastic support between the second support structure and the second screw connection.

With regard to the charge fluid cooler the object is solved by charge fluid cooler with a cooler block and a cooler housing provided with an outlet manifold, wherein the cooler housing comprises a first support part for mounting the charge fluid cooler to a cylinder head by means of a first screw connection wherein the first support part includes a support opening, the outlet manifold includes an outlet manifold-side flange connecting surface for forming a flange connection with a cylinder head-side flange connection, wherein the flange connection between the outlet manifold and the cylinder head of an internal combustion engine is held together at the side of a cross-section of an inlet passage extending through the flange connection by a first screw connection, the cooler housing includes a second support part for mounting the charge fluid cooler by means of a second screw connection to the cylinder block of an internal combustion engine, wherein, by means of the second support part, a support structure is formed for the charge fluid cooler at the second screw connection. The support opening (31) is arranged at the cooler housing so as to form an accommodation space to the manifold side flange connecting surface wherein the length of the accommodation space A is greater than the length of the support opening and the accommodation space is provided for accommodating a spacer sleeve serving the first screw connection and wherein the support formed by the second support part is a part-side rigid and a part-side elastic support member for disposition between the second support part and the second screw connection.

The invention is based on the consideration that material tensions resulting in particular from comparatively high temperature stresses of an internal combustion engine in combination with high temperature gradients with occasional additional component movements—that is relative movements between the motor block and the cooler—may occur. A component movement is in particular present in connection with high amplitude engine vibrations caused by the combustion in the engine. The invention is also based on the consideration that long-term material tensions, that is, material tensions which last over-extended periods of operation of the internal combustion engine may lead to cracks or other detrimental effects on weld connections or other joints of the charge fluid cooler. Cause of the high stresses on the cooler housing are on one hand the relative movement between parts of the engine block caused by the combustion pressure, specifically between the engine block and the cylinder head. Since the cooler housing, on the other hand, is fixed to both, parts, this leads to excessive stresses in particular in the connecting joints of the cooler housing. In addition, with different temperature stresses and different materials of the engine block on one hand and the cooler housing on the other, there are substantial material tensions between the two components and even within the cooler housing.

With the present invention, mainly detrimental effects on the cooler housing, in particular the joints of the cooler housing caused by material tensions, vibrations or other relative movements of the motor block, and the cooler are substantially reduced. The inventor has recognized that the firm fixing of the cooler to the engine block by way of the first and second screw connections is not necessarily advantageous. Rather, it has been found that different material tensions and relative movements of the involved components as well as material tensions within the cooler housing according to the invention can be comparatively well-reduced or compensated for if they are elastically accommodated and are directed at a suitable location—in particular at a distance from a flange connection between cylinder head and cooler housing—into the cooler housing. In the internal combustion engine, according to the invention, the screw connections are chosen so as to be improved in this respect.

Following the concept of the invention essentially four measures are proposed:

First, the mounting opening at the cooler housing is arranged so that a space is formed between the housing and the manifold-side flange connecting surface area. An introduction of material stress forces as they are caused by material stresses and vibrations, in particular combustion pressure forces effective on the cylinder head, is provided for at a more solid part of the cooler housing. In accordance with the invention, a length of the space is selected to be greater than a length of the mounting opening. The mounting opening is consequently sufficiently spaced from a flange connection. In particular, the length of the space ensures that the mounting opening is arranged evenly spaced from all parts of a joint connection of the cooler housing. Forces introduced into the cooler housing via the mounting opening are transmitted to a joint connection of the cooler housing comparatively uniformly and, in particular, are distributed to all parts thereof over the full length of the joint connection. The joint connection can accommodate evenly distributed forces in a more uniform way and at a greater rate whereas an only sectional stressing of the joint connection is practically prevented by the advantageous arrangement of the mounting opening. Consequently, the invention represents a departure from conventional arrangements wherein the mounting opening is arranged without any spacing thereof from the flange connection. In the arrangement according to the invention the manifold-side flange connecting surface is provided at a sufficient distance from the mounting opening at the cooler housing.

The cooler housing comprises advantageously a cooler inlet housing part, a cooler block housing part and a cooler outlet housing part which includes the outlet manifold. The cooler inlet housing part the cooler block housing part and the cooler outlet housing part are joined advantageously by means of at least one joint connection for forming the cooler housing. A first upper joint connection extends advantageously along a circumference of the cooler block housing part and the cooler outlet housing part which are interconnected. A second lower joint connection extends advantageously along a circumference of the cooler block housing part and the cooler inlet housing part which are interconnected thereby. The mounting opening is arranged so as to be spaced essentially uniformly from the above mentioned joint connections.

Secondly, it is proposed by the invention that the first screw connection extends through a force-accommodating spacer sleeve arranged in the accommodation space. In particular, a screw or bolt of the first screw connection extends through the spacer sleeve wherein the screw abuts with its screw head the side of the mounting opening remote from the accommodation space. The screw or bolt is screwed with its other end advantageously into the cylinder head-side flange connection or is otherwise fixed. Furthermore, with the use of a spacer sleeve, the first screw connection at the cylinder head has been found to be comparatively elastic so as to compensate effectively for heat expansions. At the same time, with the use of a spacer sleeve, the first screw connection is sufficiently rigid for a reliable positioning of the cooler housing relative to the cylinder head. The load accommodating spacer sleeve according to the invention transmits, and compensates for, forces occurring between the cylinder head and the mounting spacing and, at the same time, defines the distance between the cylinder head and the cooler housing in such a way that a flange connection is established by the first flange connection with sealing tightness.

Thirdly, the flange connection is established with a gap between the manifold-side and the cylinder head-side flange connecting surfaces sufficient for the accommodation of a seal. It should be understood that the seal is designed on one hand for providing an appropriate sealing of the gap. On the other hand, the gap is determined by the spacer sleeve such that, between the manifold-side and the cylinder head side flange connecting surfaces, practically no force transmitting contact is established. The concept consequently provides for a relative gap which is so dimensioned that even at high operating loads no contact occurs between the manifold-side and the cylinder-side flange joint surfaces. This is also true even with relative movements between the motor block and the cooler housing as well as during material expansions occurring a result of material stresses or other causes such as different heat expansions during operation of the internal combustion engine in the motor block and the charge fluid cooler and also within the housing parts. In particular, with the relief gap, a non-symmetric introduction of forces into the cooler housing via the flange connection is avoided. The concept according to the invention ensures that an introduction of forces into the cooler housing from the cylinder head occurs practically exclusively via the mounting opening which is assigned to the cylinder head and spaced from the flange connection.

Fourth, with the arrangement according to the invention, a partially fixed and partially elastic support part is formed by the second support structure between the second support part and the second screw connection. The partially elastic structure of the support part is suitable to compensate for comparatively large heat-caused material expansions at the cooler housing and also to compensate for manufacturing tolerances. The partial fixed arrangement of the support part still provides for a secure connection of the cooler housing to the engine block. In particular, the cooler housing is fixed via the second support part to the engine block. Preferably, the support part is in the form of a pivotal pendulum support. It is advantageous if a support part is provided which is elastic in the upward and in the longitudinal direction of the engine but is relatively rigid in the transverse engine direction.

With the above-mentioned four design features, an improved compensation between forces occurring between the engine block and the cooler housing as well as an improved introduction of forces into the cooler housing are achieved. Still, a secure connection of the cooler housing to the engine block is ensured. With the combination of (1.) a mounting opening arranged at a distance from the manifold-side flange connecting surface and (2) a load accommodating spacer sleeve advantageously supported on block and (3.) a relief gap provided at the cylinder head as well as (4.) a partially fixed and partially elastic support part at the cylinder block, a cooler housing and in particular the joint connection between the housing parts of the cooler housing are effectively relieved from stresses. A stress relief of the cooler housing is ensured even at high temperature changes or high temperature gradients even and increased component movements during long time stress loads of the internal combustion engine.

The inventive concept can be realized relatively easily even in connection with existing internal combustion engines. Conventional internal combustion engines as disclosed for example in DE 10 2007 045 196 A1 have for example altogether two screw connections per cylinder head wherein in each case one of the screw connections is formed at one side of the cross-section of the charge fluid inlet channel. This screw connection extends herein in a mounting opening whose support surface facing the cylinder head is an integral part of the manifold flange connecting surface. The integral mounting opening can be reduced to a mounting opening according to the invention while forming an accommodation space between the manifold support surface of the mounting opening. Also, a load supporting spacer sleeve may be arranged in the accommodation space. In this way, the concept according to the invention can be realized comparatively easily also in connection with internal combustion engines which are already in operation.

The invention and various embodiments thereof will become more readily apparent from the following description particular embodiments thereof on the basis of the accompanying drawings.

In a first variant, the internal combustion engine may have a number of cylinder heads which are combined in a common cylinder head block which is mounted onto the cylinder block. Particularly effective is the concept according to the invention also in connection with a second variant wherein the cylinder head is formed as one of a number of individual cylinder heads which are all mounted separately to the cylinder block. In both variants, the combustion pressure generates a shock movement of the cylinder head with a comparatively large relative movement of the cylinder block and the cylinder head which leads to stresses in the cooler housing. The relative movement is accommodated with the invention in an improved manner.

In connection with a preferred further embodiment, the cylinder head may be a part of a cylinder head block or an individual cylinder head attached to the charge fluid cooler by a single screw connection. This embodiment is considered to be particularly advantageous because of installation space limitations as they occur for example in the exhaust manifold by the installation therein of an electric heating element. Such a heating element is described for example in DE 10 2007 045 196 A1 for an exhaust gas manifold. DE 10 2007 045 196 A1 is enclosed herewith by reference with respect to the electric heating element and the arrangement thereof. The cooler housing, advantageously the cooler inlet housing part, includes a charge fluid inlet manifold. Preferably, the charge fluid cooler is connected to the cylinder head via the single first screw connection at a side of the cross-section of the charge fluid channels facing away from the charge fluid inlet manifold. In another embodiment, the charge fluid cooler may be connected to the cylinder head by two of the first screw connections. In other words, the charge fluid cooler, that is, a cooler housing or, respectively, a cooler outlet housing part, is attached to the cylinder head only by one or several first screw connection according to the concept of the invention. A first screw connection according to the invention is a screw connection attached at the mounting opening using a spacer sleeve in the accommodation space area and with a relief gap between the manifold-side and the cylinder side flange connecting surface areas. A direct contact between the manifold-side and the cylinder-side flange connecting surface areas is prevented to avoid a force transfer into the cooler housing at a location considered to be unfavorable.

A release gap of a width of 0.1 to 0.9 mm, especially in the area of only 0.3 to 0.5 mm, has been found to be particularly advantageous. If necessary, the relief gap may also be larger, for example in the range of 1 to 4 mm and particularly 2 to 3 mm. A seal arranged between the manifold-side and the cylinder head-side flange connecting surface is particularly advantageously disposed in a groove of the manifold-side flange connecting surface.

Furthermore, it has been found to be sufficient to provide a single second screw connection that is in particular a single support structure for the second support part of the charge fluid cooler. Although, in principle several support structures may be provided, it has been found that, when necessary also a single support structure would be sufficient for supporting the charge fluid cooler by a cooler inlet housing part.

The elastic support part is advantageously in the form of a pendulum support member which provides for a resilient support in the height extension of the engine block and in the longitudinal engine direction and a comparatively rigid support in a transverse direction. In this way, the cooler housing is rigidly supported transverse to the engine. On the other hand, in the height direction and the length direction of the engine a comparatively high elasticity is obtained.

The spacer sleeve advantageously abuts directly the mounting opening and the cylinder head-side flange connection surface, that is, the spacer sleeve is at both ends in direct contact with the components to be interconnected. Basically, a spacer sleeve could also be indirectly, via other spacer means, in contact with the support opening and/or the cylinder head-side flange connecting area. In the arrangement as presented herein, the length of the spacer sleeve corresponds to the length of the accommodation space. It is considered to be particular advantageous that the length of the spacer sleeve is greater than the length of the support opening. Preferably, the length of the spacer sleeve is only slightly less than the clamping length of the screw bolt of a screw in the first screw connection. It has been found suitable if the clamping length of the screw bolt corresponds to at least three times, and in particular five times the diameter of the screw bolt. In this way, a self-locking of the screw connection by a sufficient elasticity of the screw connection in load direction over the length of the screw bolt is ensured. It is also advantageous if the length of the spacer sleeve and/or the installation space is so selected that it is at least three times, and in particular at least five times the diameter of the screw bolt.

The mounting opening is preferably formed integrally on the cooler outlet housing part with a recessed base radius. The base radius extends advantageously into the mounting space. In this way, notch effects can be avoided even with high tensions and high force transmissions between the mounting opening and the cooler housing via the mounting opening. Also, a base radius in the area of 4 mm has been found to be particularly advantageous.

Furthermore, a spacer sleeve with a particular wall has been found to be advantageous that is a wall wherein the wall thickness differs in a section thereof. In other words, the wall thickness is increased at one end thereof. In connection with a particularly advantageous further development, the spacer sleeve has a wall provided at a first end of increased wall thickness with a radially outwardly extending collar and/or at a second end of increased wall thickness with a radially inwardly extending collar. A radially inwardly extending collar is advantageously arranged at the support surface of the support opening. In this way, the support surface area of the spacer sleeve can be increased while a screw bolt is centered in the screw connection. A radially outwardly extending collar of the spacer sleeve is preferably disposed at the cylinder head side flange connecting surface area. In this way, advantageously, the support surface area and the radius of the support surface area at the cylinder head side flange connecting area are increased. Also, with a reduced wall thickness in the center area of the spacer sleeve, the spacer sleeve has a certain elasticity. The spacer sleeve can be made of a high-quality material such as steel and, with the ends of increased wall thickness over the center area, has a high elasticity for accommodating heat expansion but still provides for sufficient stability and advantageous support surface areas.

Further advantages, features and particulars of the invention will become apparent from the following description of preferred exemplary embodiments with reference to the drawings.

The exemplary embodiments are not necessarily presented to scale but rather the drawings are schematic. With regard to additions to the teaching directly recognizable from the drawings reference is made to respective state of the art. It has to be taken into consideration that many modifications and variations with respect to form, and details of an embodiment are possible without deviation from the concept of the invention. The inventive features disclosed in the description, in the drawings and in the claims may be important individually as well as in any combination for the further development of the invention. Also included, in the frame of the invention are all combinations of at least two of the features disclosed in the description of the drawings and/or the claims. The general concept of the invention is not limited to the exact form or details of the embodiments as shown and described below, or limited to a feature which may be limited in comparison with the subject matter as defined in the claims. For the range limits provided, values disposed within the indicated limits disclosed should be valid and claimable. For reasons of simplicity below identical or similar components or parts with identical or similar functions are identified by the same reference numerals.

### BRIEF DESCRIPTION OF THE DRAWINGS

FIG. 1 is a perspective view of an internal combustion engine including an engine block and a charge fluid cooler, wherein a flange connection is provided at the side of a cross-section of a charge fluid inlet channel and the cooler is supported by a first screw connection disposed between a single cylinder head and an associated outlet manifold of the cooler housing of the charge fluid cooler.

FIG. 2 is a perspective detail view of a cooler outlet housing part of the cooler housing with several outlet manifold structures in the area of the individual cylinder heads according to FIG. 1,

FIG. 3A is a side view of a detail of FIG. 2 shown in the transverse engine direction X,

FIG. 3B is a sectional view of the first screw connection for a single cylinder head and outlet manifold of FIG. 3A taken along line A-A,

FIG. 3C is a sectional view of the first screw connection of FIG. 3A taken along line C-C,

FIG. 4A is a sectional view of a single cylinder head and the outlet manifold of FIG. 3A taken along line B-B,

FIG. 4B shows a detail X2 of FIG. 4A in the area of the flange connection showing the relief gap,

FIG. 5 is a sectional side view of a screw connection of the internal combustion engine of FIG. 1 in the area of a flange jointure between the cylinder head and the outlet manifold indicating the recessed base radius between the support opening and the cooler outlet housing part, and

FIG. 6 represents another detail of the internal combustion engine of FIG. 1 showing a second screw connection in the form with a partially rigid and partially elastic support provided by a pendulum support member.

### DESCRIPTION OF PARTICULAR EMBODIMENTS

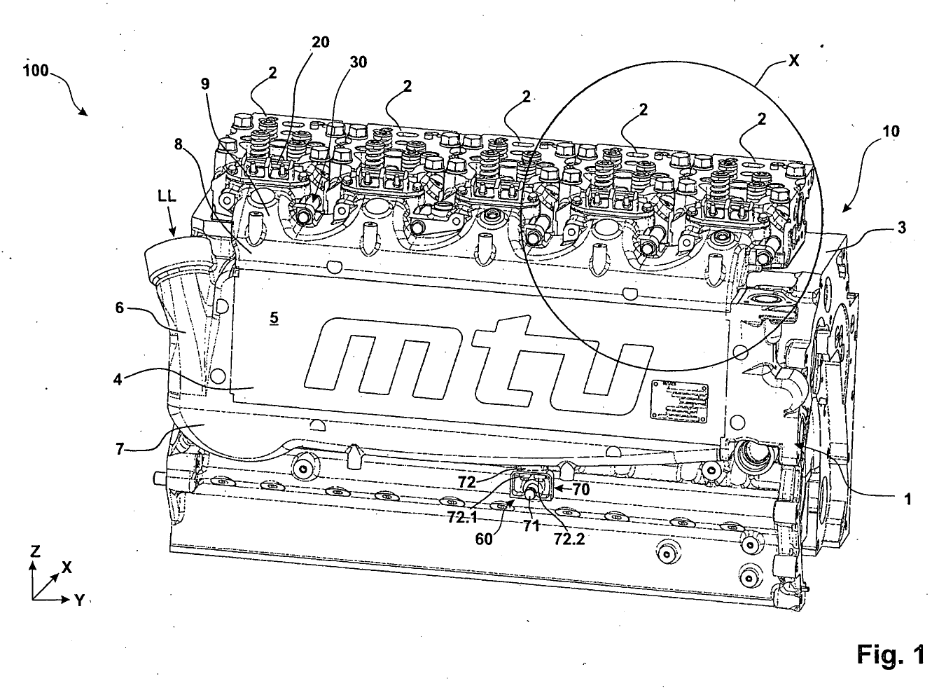

FIG. 1 shows an internal combustion engine 100 with an engine block 10 and a charge fluid cooler 1—in this case for charge air—mounted to the engine block 10 by a number of screw connections 30, 60. The engine block 10 is a building component to which the charge fluid cooler 1 (cooler) is connected for forming the internal combustion engine. The engine block 10 includes the cylinder block 3 with part of the crankcase and a number of, in this case, five cylinder heads 2 which in the shown embodiment an individual cylinder heads each being separately mounted to the engine block 3. In accordance therewith, the cooler 1 has one cooler housing 5, which includes a cooler outlet housing part 8 with a number—in the present case five—outlet manifold exit passages 9 for the admission of charge air LL to the cylinders of the engine block 10. The charge air LL is supplied to the cooler 1 via an inlet manifold with inlet stubs 6 and then to a cooler inlet housing part 7. The charge air LL is then cooled in a cooler block housing part 4 which is disposed below the cooler outlet housing part 8 and includes a cooler block (not shown). The cooler housing 5 comprises a cooler inlet housing part 7, a cooler block housing part 4 and a cooler outlet housing part 8 which are joined by means of two weld joints which extend along the circumference of the housing parts 7, 4, 8, but which are not indicated. The cooler housing 5 is firmly mounted to the engine block 10. Via the outlet housing part 8, that is, the outlet manifold 9 the cooler housing 5 is connected to the cylinder head 2 by a first screw connection 30, whereas the cooler inlet housing part 7 is connected to the cylinder block 3 via a pendulum support 70 described in detail further below. To this end, the cooler housing is provided below at the cooler inlet housing part 7 with a support structure 72 which forms support for the charge fluid cooler 1 at a second screw connection 60. The pendulum support 70 is in this case arranged between the second support part 72 and the second screw connection 60. The second support part 72 itself is connected to the pendulum support 70 via two further mounting screws 72.1, 72.2. The second screw connection 60 is in this case in the form of a pendulum screw 71 with the two mounting screws 71.1, 72.2, for connecting the pendulum support 70 at one end to the second support part 72 and to the engine block at the other end. The first screw connection 30 provides for a connection of the outlet manifold to the cylinder head 2 as will be described further below.

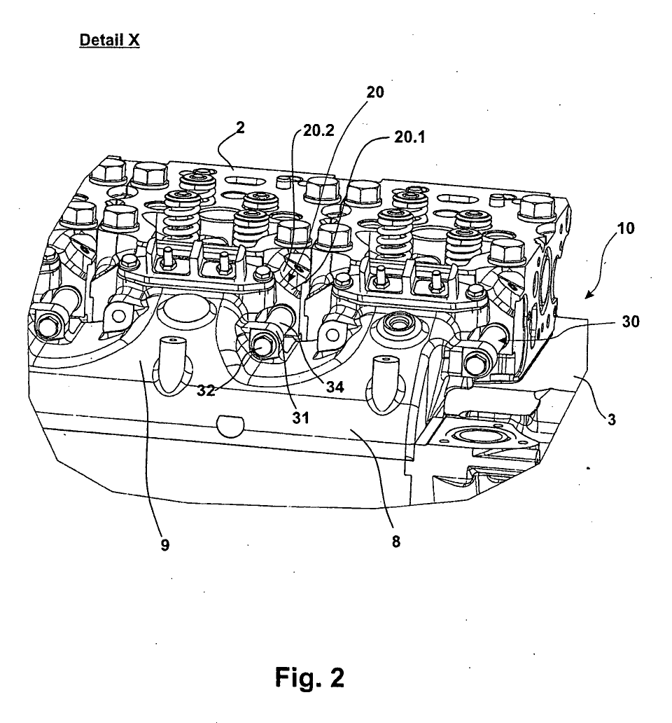

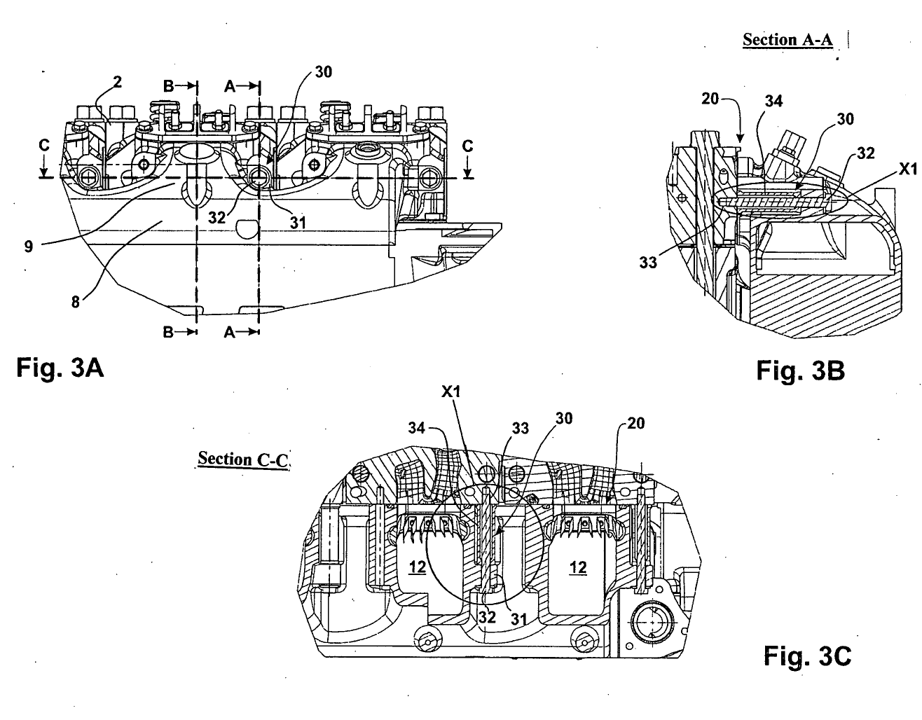

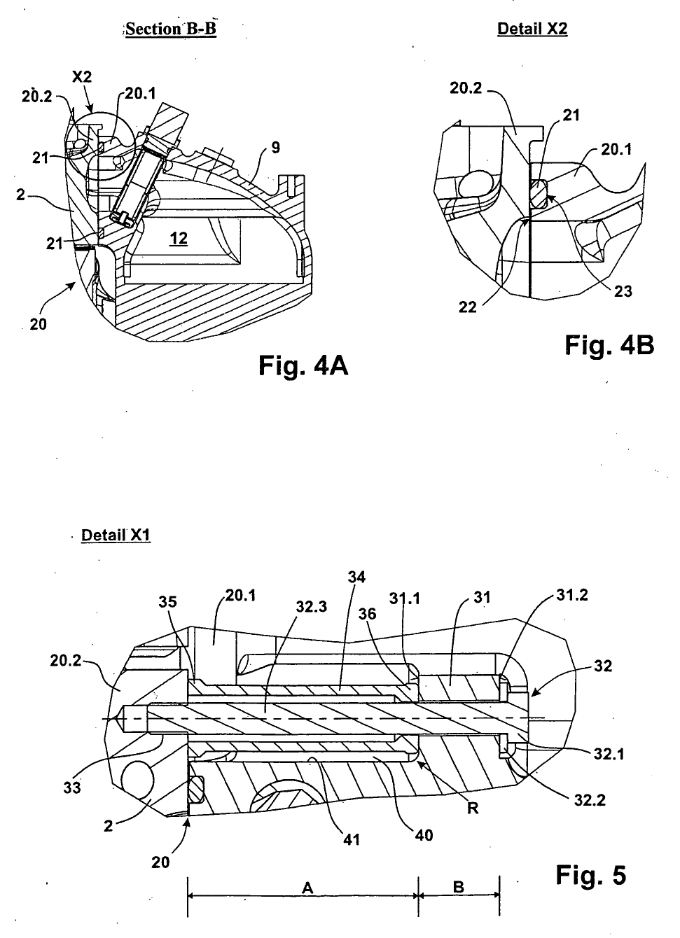

The cooled charge air is conducted to the outlet manifold 9 of the cooler outlet housing part 8 and from there further via the cylinder head 2 to a cylinder of the engine block 3. To this end, the cylinder head 2 and the outlet manifold 9 form an air inlet passage 12 extending through a flange connection 20 which is indicated in FIGS. 3B, 3C, 4A and leads to a cylinder of the cylinder block 3. In accordance with the embodiment shown in FIG. 1, the outlet manifold 9 and the cylinder head 2 are joined without interposition of a charge air pipe via the flange connection 20 shown in greater detail in FIG. 2. That is a flange connecting surface 20.1 of the outlet manifold 9 and a flange connecting surface 20.2 of the cylinder head 2 are arranged directly opposite each other.

In a modified embodiment, the cylinder head 2 may be in the form of a cylinder head block that is an integral component that is not in the form of individual cylinder heads 2 as shown in FIG. 2.

The air inlet passage 12 is completely open between the combustion chamber in the cylinder of the engine block 10 and the cooler 1. Here, the charge fluid cooler is an air/water cooler in which heat is transferred from the charge air LL to the water. To this end, the cooler is provided at a side opposite the inlet manifold 6 with coolant connections which are not shown in detail but via which coolant is supplied to the cooler block in the cooler block housing part 4.

The above-mentioned flange connection 20 includes a flange connecting surface 20.1 of the exhaust manifold 9 and a flange connecting surface 20.2 of the cylinder head 2 as shown in FIG. 2. The flange connecting surface 20.1, 20.2 are held in engagement at the side of a cross-section of the charge fluid inlet channel 12 between the cylinder head 2 and the exhaust manifold 9 by means of a first screw connection 30. Actually, the first screw connection 30 is engaged at one end in a support opening 31, the support opening being formed on the cooler outlet housing part 8, specifically, directly on the outlet manifold 9, together with the cast housing of the cooler 1. Furthermore, the screw connection 30 includes a screw 32 which is screwed with respect to FIG. 3C, FIG. 5 further down in a threaded part 33 of the cylinder head 2 so as to form a pull connection. The first screw connection 30 also includes a spacer sleeve 34 whose arrangement is described with respect to FIG. 3A to FIG. 5.

FIG. 3A shows part of FIG. 2 in a full side view in the transverse engine block direction X of the internal combustion engine 100. A sectional view along the sections A-A and C-C of FIG. 3A is shown enlarged in FIGS. 3B and 3C. With respect to FIGS. 3B and 3C, it is noted that the air inlet channel 12 is shown therein and also visible in detail X1. Also the first screw connection 30 with the screw 32, the mounting opening 31, the spacer sleeve 34 and the threaded part 33 as well as the flange connection 20 are shown. The detail X1 of FIG. 5 shows the flange connection 20 with the flange connecting surface areas 20.1, 20.2 in an enlarged representation.

With reference to FIG. 5, the mounting opening 31 is arranged on the cooler outlet housing part 8, that is, at the outlet manifold 9 while forming an intermediate space A over the flange connecting surface 20.2 of the cylinder head 2. Actually, on a side of the outlet manifold 9 facing the flange connecting surfaces 20.2 of the cylinder head 2, the outlet manifold is provided with a flange connecting surface 20.1 which define with their opposite surfaces the flange connection 20. The mounting opening 31 includes a support surface 31.1 which faces the flange connecting surface 20.2 of the cylinder head 2 or, respectively, the flange connecting surface 20.1 of the outlet manifold 9, which forms a space A between the flange connecting surface area 20.1 and the support surface 31.1—that is, the support surface 31.1, in a side view of FIG. 5 is recessed or, respectively, free. On the screw surface 31.2 of the support opening 31 opposite, the support surface 31.1, the head 32.1 of the screw 32 is arranged under which in the present case a spring disc 32.2 is disposed. In the space A which, as described above, is formed by the distance of the support surface 31.1 from the outlet manifold-side flange connecting surface 20.1, a spacer sleeve 34 is arranged. A screw bolt 32.3 extends within the spacer sleeve 34 and is threaded into the thread part 33 of the cylinder head 2. The spacer sleeve 34 is disposed directly in contact with the support opening 31, that is, at the support surface 31.1 as well as the flange connecting surface area 20.2 of the cylinder head 2, it is fixedly supported at both ends. In this way, with the first screw connection 30 a stressable connection between the cylinder head 2 and the cooler 1 is established. As a result, a weld connection between the housing parts 7, 8, 4 of the cooler 1 which weld connection is not shown, is uniformly stressed in an advantageous manner since the forces on the cylinder head 2 can be transmitted to the cooler housing 5 only via the support opening 31. On one hand, forces are transmitted to the outlet housing part 8 of the cooler 1 via the support opening 31, which is spaced from the flange connection 20, into a comparatively rigid housing part of the cooler 1. On the other hand, the tension connection formed by the first screw connection 30 is relatively elastic because of the spacer sleeve 34 arranged in the space A. Although the first screw connection 30 is sufficiently rigid to safely position the cooler 1 on the motor block 10, the spacer sleeve 34 disposed as separate part between the mounting opening 31 and the flange connection 20 accommodates elastically material tensions which occur for example as material volume changes or movement amplitudes. The first screw connection 30 is advantageously also in a position to elastically accommodate temperature variation stresses, high temperature gradients and material tensions caused by relative movements of components and still provide for a secure positioning of the charge air cooler 1 on the engine block 10 via the cylinder head 2 and the outlet manifold 9. This has substantial advantages over a comparatively rigid connection of the charge air cooler 1 to the engine block 10 via a solid material support opening as it is shown in DE 10 2007 045 196 A1 whose support surface is part of a flange connecting surface whereby it is part of a connecting surface between the cooler 1 and the motor block 10. Via such a connecting surface area as it is provided in the state of the art material tensions are directly and possibly only at one side transmitted to the connecting joint of the cooler 1. During long-time stressing, this may detrimentally affect the joint connection or respectively, the cooler housing 5. In contrast with the mounting opening 31 recessed and spaced from the flange connection 20 and joined via a spacer sleeve 34 the problems encountered by the conventional arrangement are eliminated.

To improve the mechanical properties of the spacer sleeve 34, it is provided with enlarged end sections in the form of radial collars 35, 36 as shown in FIG. 5. A first radially outwardly extending collar 35 is disposed on the cylinder head 2, that is, it abuts a cylinder head-side flange connecting surface 20.2. With the radially outwardly extending first collar 35, the contact area and the contact radius of the spacer sleeve 34 on the cylinder head side flange connecting surface 20.2 are effectively increased. A second radially inwardly extending collar 36 is disposed on the support surface 31.1 of the support opening 31 and in this way increases the support surface area of the spacer sleeve 34 at the support opening 31. With the collars 35, 36, the load accommodation of the spacer sleeve 34, or respectively, the force transmission capacity of the spacer sleeve 41 is increased. In addition, the radially inwardly directed second collar 36 acts, because of its opening being adjusted to the diameter of the screw bolt 32.3, as guide means for the screw 32. Because of its comparatively thin-walled center section between the collars 35, 36, the spacer sleeve has a certain elasticity permitting it to accommodate heat expansions or vibrations of the cylinder head 2 elastically or at least to dampen them. The spacer sleeve may consist of heat-expansion accommodating materials such as steel providing for high stability.

The space A is basically so dimensioned that the first screw connection 30, that is, in particular the screw bolt 32.3 and the spacer sleeve 34, can have sufficient elasticity. To this end, the length of the space A is greater than a length B of the support opening 31. The length B of the support opening 31 is the distance between the support surface 31.1 and the screw area 31.2. It has been found to be particularly advantageous if the length of the space A and the length of the spacer sleeve 34 are greater than three times the diameter of the screw bolt 32.3. In the present case, the length of the space A and the length of the spacer sleeve 34 are over five times the diameter of the screw bolt 32.3, that is, in the area of seven times the diameter of the screw bolt 32.3. These dimensions ensure a sufficient clamping length of the screw 32 which is defined by the overall-length of the screw bolt 32.3 or, respectively, the length of the space A minus the width of the mounting opening B. With a clamping length selected in this way a self-locking of the first screw connection 30 as a result of the stretching of the screw bolts 32.3 with a certain tightening torque is achieved.

The first screw connection 30 is also arranged largely in a recess 40 forming the space A as shown in FIG. 5. The spacer sleeve 34 is arranged in the recess 40 wherein the base surface of the recess 40 is formed by the support surface 31.1 of the mounting opening 31 as earlier explained. The transition from the base surface of the recess 40 to a side surface 41 of the recess 40 is characterized by a radius R with a length of about 2.5 mm. It has been found that with such a radius R a corner stress between the support surface 31.1 and the side surface 41 in the recess 40 caused by the transmission of forces via the spacer sleeve to the support opening 31 can be reduced.

In addition to a suitable material reinforcement in the housing area around the support opening 31 at the outlet manifold 9 a curved area with a radius R increases the force accommodation capability of the support opening 31 in the recess 40.

A further advantageous constructive realization of the first screw connection 30 in the area of the flange connection 21 is shown in FIG. 4A in combination with the enlarged representation of detail X2 shown in FIG. 4B. In the sectional view B-B of FIG. 3A, the motor block 10 is shown together with the outlet manifold 9 and the flange connection 20. The flange connection 20 shown enlarged in the detail X2 shows a seal 21 arranged in the groove 23 of the flange connection 20. In addition, it is apparent from detail X2 that, between the flange connection surface 20.2 of the cylinder head 2 and the flange connecting surface 20.1 of the outlet manifold 9, a relief gap is formed extending over the whole surface area of the flange connection 20. The relief gap 22 has in the present case a width of about 0.2 to 0.3 mm. With the relief gap 22 comparatively vertical movements of a cylinder head 2 during the power stroke can be accommodated relatively easily. The relief gap 22 may also have a greater width, preferably a width in the range of 2 to 3 mm. A movement of the cylinder head 2 causing material tensions can occur in the relief gap 22 without affecting the neighboring part, in this case, in particular the charge air cooler 1. Also, a force transmission or a material tension into the adjacent cooler housing 5 at the flange connection 20 is reduced as the flange is sealed only by the seal 21 in the groove 23. A sealing tightness of the flange connection 20 is not detrimentally affected because of the seal 21. The relief gap 22 and consequently, the engagement pressure of the seal 21 in the groove 23 between the flange connecting areas 20.1 and 20.2 is provided by the spacer sleeve 34 which is firmly engaged. Finally, the provision of a spacer sleeve 34 together with a relief gap 22 results in an effective uncoupling of the cylinder head 2 and the outlet manifold 9. Material tensions still transmitted between the engine block 10 and the charge air cooler 1 are transmitted only via the support opening 31 into a solid part of the outlet housing 8 of the charge air cooler 1. The force transmission is therefore comparatively secure and reliable. To this end, the housing area around the support opening 31 may also be reinforced.

A first screw connection 30 can be installed also in an already existing housing of a charge air cooler 1. Mounting openings of conventional arrangements which may be provided in a cast housing of the charge air cooler 1 and which extend up to the flange connecting surface 20.1 of the charge cooler 1 may be fully or partially established, as shown in FIGS. 1 and 2, only at a side of the cross-section of the charge fluid inlet passage 12 remote from the inlet manifold, that is a mounting opening 31 in accordance with the concept of the invention may be formed. For establishing a first screw connection 30, a screw 32 may be inserted into the mounting opening 32 and may be tightened to a threaded part 33 of the cylinder head 2 via a spacer sleeve 34 as explained above.

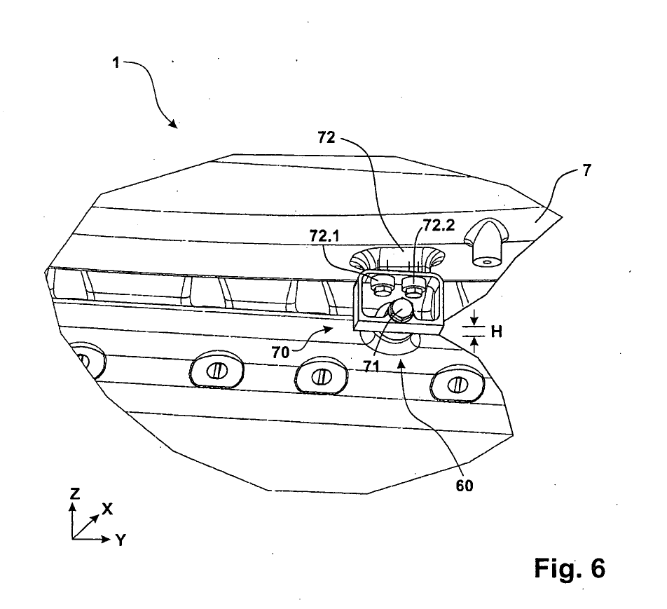

FIG. 6 shows the elastic support structure including a pendulum support member 70 as indicated already in FIG. 1 in connection with a second screw connection 60. This advantageously compensates for manufacturing tolerances and other volume changes of the cooler 1 relative to the engine block 10. The pendulum support member 70 comprises a box structure with a height H which extends in an engine block transverse direction X according to FIG. 1. The pendulum support structure 70 is supported centered by a single pendulum screw 71 of the second screw connection 60. At a side of the box structure opposite the pendulum screw 71, the charge air cooler 1 is supported by two mounting screws 72.1, 72.2 of the screw connection 60. The pendulum support member 70 can move elastically utilizing the pendulum screw 71 provided for the support of the pendulum support structure 70. It provides for spring support in the height direction Z of the engine and pendulum support in the longitudinal engine direction Y. In this way, the charge air cooler 1 is partially supported by the pendulum support structure 70 on the cooler inlet housing part 7 arranged at the bottom of the cooler outlet housing part 8 in a fixed manner (that is in engine block transverse direction X) and partially elastically (that is in engine block height direction Z and in engine block longitudinal direction 7.

With the first screw connection 30 and the second screw connection 60 according to the invention, the charge air cooler 1 is safely and securely connected to the engine block 10 but with a certain elasticity in certain directions. In addition, component movements can be accommodated by the relief gap 22 referred to earlier. All these measures together result in a load relief of the cooler housing 5 or respectively, the weld connections at the charge fluid cooler 1 even with extended and high stress loads of the components under temperature charges and relative component movements.

In summary, the invention relates to an internal combustion engine 100 with a motor block 10 and a charge fluid cooler 1 mounted to the motor block 10 wherein the motor block 10 comprises a cylinder block 3 and a cylinder head 2 mounted onto the cylinder block 3, and wherein the charge fluid cooler 1 includes a cooler block and a cooler housing 5 with an outlet manifold 9, and the cooler housing 5 has a first support part for mounting the charge fluid cooler 1 to the cylinder head 2 by means of a first screw connection 30, wherein the first support part includes a mounting opening 31, and the outlet manifold 9 has an outlet manifold-side flange connecting surface 20.1 for forming a flange connection 20 between the outlet manifold 9 and the cylinder head 2 with a cylinder head-side flange connecting surface 20.2, wherein the flange connection 20 is mounted by the first screw connection at the side of a cross-section of a charge fluid inlet channel extending through the flange connection, and the cooler housing 5 has a second support part 72 for mounting the charge fluid cooler to the engine block 3 by means of a second screw connection 60, wherein by means of the second support part 72 at the second screw connection 60, a support structure for the charge fluid cooler 1 is formed. In accordance with the invention, the support opening 31 is formed on the cooler housing 5 while forming a space A at the manifold-side flange connecting surface 20.1 wherein the length of the space A is greater than the length B of the mounting opening 31 and the first screw connection 30 extends through a spacer sleeve 34 which is arranged in the space A and accommodates the engagement load and wherein the support formed by the second support part 7 is a partially rigid and a partially elastic support part disposed between the second support part 72 and the second screw connection 60.

The invention further resides in a charge fluid cooler 1 with a cooler block and a cooler housing 5 with an exhaust manifold 9,

and the cooler housing 5 comprises a first support part for mounting the charge fluid cooler 1 to the cylinder head 2 by a first screw connection 30 wherein the first support part includes a support opening 31,

and the outlet manifold 9 has an outlet manifold-side flange connecting surface 20.1 for forming a flange connection 20 between the outlet manifold 9 and the cylinder head 2 of an internal combustion engine 100 with a cylinder head-side flange connecting surface 20.2 wherein the flange connection 20 is mounted by the first screw connection 30 at the side of a cross-section of a charge fluid inlet channel extending through the flange connection 20,

and the cooler housing 5 has a second support part 72 for the attachment of the charge fluid cooler 1, by means of a second screw connection 60, to the cylinder block 3 of an internal combustion engine 100, wherein, by means of the second support part 72, a support for the charge fluid cooler 1 on the second screw connection 60 can be formed. In accordance with the invention, the support opening 31 is arranged on the cooler housing 5 at a distance A from the manifold-side flange connecting surface 20.1, wherein the length of the space A is greater than the length B of the support opening 31 and the space A accommodates a load transmitting spacer sleeve 34 of the first screw connection 30 and wherein the support formed by the second support part 72 forms a partially rigid and partially elastic support arrangement between the second support part 72 and the second screw connection 60.

Listing of Reference Numerals

| A | Space |
|---|---|
| B | Length of the support spring |
| R | Radius |
| X | Engine block transverse direction |
| Z | Engine block height direction |
| Y | Engine block length direction |
| LL | Charge air |
| H | Height of box structure |
| 1 | Charge fluid cooler |
| 2 | Cylinder head |
| 3 | cylinder block |
| 4 | Cooler block housing part |
| 5 | Cooler housing |
| 6 | Inlet manifold |
| 7 | Cooler inlet housing part |
| 8 | Outlet housing part |
| 9 | Outlet manifold |
| 10 | Engine block |
| 12 | Air inlet passage |
| 20 | Flange connection |
| 20.1 | Flange connecting surface |
| 20.2 | Flange connecting surface |
| 21 | Seal |
| 22 | Relief gap |
| 23 | Groove |
| 30 | First screw connection |
| 31 | Support opening |
| 31.1 | Support surface |
| 31.2 | Screw area |
| 32 | Screw |
| 32.1 | Head |
| 32.2 | Spring disc |
| 32.3 | Screw bolt |
| 33 | Thread part |
| 34 | Spacer sleeve |
| 35 | First radial collar |
| 36 | Second radial collar |
| 40 | Recess |
| 41 | Side surface |
| 60 | Second screw connection |
| 70 | Pendulum support member |
| 71 | Pendulum screw |
| 72 | Support part |
| 72.1, 72.2 | Mounting screws |
| 100 | Internal combustion engine |

What is claimed is:

1. An internal combustion engine (100) including a motor block (10) with a charge fluid cooler (1) mounted thereon,
the motorblock (10) comprising a crankcase with a cylinder block (3) and a cylinder head mounted onto the cylinder block (3) and the charge fluid cooler (1) comprising a cooler block and a cooler housing (5) with an outlet manifold (9),
the cooler housing (5) having a first support part for supporting the charge fluid cooler (1) on the cylinder head (2) by means of a first screw connection (30), the first support part including a support opening (31) and the outlet manifold (9) including an outlet manifold-side flange connecting surface (20.1) for forming a flange connection (20) with a cylinder head-side flange connecting surface (20.2),
the flange connection (20) between the outlet manifold (9) and the cylinder head (2) being held together by the first screw connection (30), which is disposed at the side of a cross-section of a charge fluid inlet passage (12) extending through the flange connection (20) and
the cooler housing (5) having a second support part (72) for mounting the charge fluid cooler (1) to the cylinder block (3) by means of a second screw connection (60),
the support opening (31) being arranged at the cooler housing (5) in spaced relationship from the outlet manifold-side flange connecting surface (20.1) so that an accommodation space (A) is formed between the outlet manifold side flange connecting surface (20.1) and the mounting opening (31) which accommodates space (A) has a length exceeding a length (B) of the support opening (31), a load accommodating spacer sleeve (34) being disposed in the accommodation space (A) with the first screw connection (30) extending through the spacer sleeve (34),
the flange connection (20) being established with a relief gap (22) remaining between the manifold-side (20.1) and the cylinder head-side (20.2) flange connecting surfaces with a seal disposed in the relief gap (22), and
the second support part (72) being formed by a partially, that is in one direction, rigid and partially, that is in another direction, elastic support disposed between the second support part (72) and the second screw connection (60).

2. The internal combustion engine according to claim 1, wherein the cylinder head (2) is one of a number of cylinder heads which together form a cylinder head block mounted onto the cylinder block (3).

3. The internal combustion engine according to claim 1, wherein the cylinder head (2) is one of a number of individual cylinder heads which are separately mounted onto the cylinder block (3).

4. The internal combustion engine according to claim 1, wherein the charge fluid cooler (1) is attached to the cylinder head (2) by a single first screw connection (30).

5. The internal combustion engine according to claim 4, wherein the charge fluid cooler (1) includes a charge fluid inlet manifold (6) and the charge fluid cooler (1) is attached to the cylinder head (2) by a single first screw connection (30) disposed at a side of the cross-section of the charge fluid inlet passage (12) facing away from the charge fluid inlet manifold (6).

6. The internal combustion engine according to claim 1, wherein the charge air cooler (1) is attached to the cylinder head (2) by two first screw connections (30).

7. The internal combustion engine according to claim 1, wherein the charger inlet housing part (7) is attached to the cylinder block (3) by a single second screw connection (60).

8. The internal combustion engine according to claim 1, wherein the spacer sleeve (34) abuts directly or indirectly the support opening (31) and the cylinder head side flange connecting surface (20.2).

9. The internal combustion engine according to claim 1, wherein a clamping length of a screw of the first screw connection (30) or the length of the spacer sleeve (34) and the length of the accommodation space (A) is at least three times the diameter of the screw.

10. The internal combustion engine according to claim 1, wherein the support opening (31) is formed integrally with a spot-faced base radius on the cooler outlet housing part (8) with a base radius of 1 to 4 mm, the base radius being arranged in the accommodation space (A).

11. The internal combustion engine according to claim 1, wherein, between the outlet manifold-side and the cylinder head-side flange connecting surfaces (20.1, 20.2, a seal (21) is arranged in a groove (23) of the manifold-side flange connecting surface (20.1).

12. The internal combustion engine according to claim 1, wherein the spacer sleeve (34) has a wall, which includes at least one of a first end with an enlarged wall thickness provided by an outwardly extending collar (35) and a second end with an enlarged wall thickness formed by an inwardly extending collar (36).

13. The internal combustion engine according to claim 1, wherein the partially rigid and partially elastic support part is in the form of a pendulum support (70).

14. The internal combustion engine according to claim 1, wherein the partially rigid and partially elastic support part includes a box profile extending in the engine block height direction (2) and the engine block longitudinal direction (Y) and a box height (H) extending in the engine block transverse direction (X).

15. A charge fluid cooler (1) with a cooler block and a cooler housing (5) provided with an outlet manifold (9), the cooler housing (5) comprising:
a first support part for mounting the charge fluid cooler (1) to a cylinder head (2) by means of a first screw connection (30) wherein the first support part includes a support opening (31),
the outlet manifold (9) includes an outlet manifold-side flange connecting surface (20.1) for forming a flange connection (20) with a cylinder head-side flange connecting surface (20.2), wherein the flange connection (20) between the outlet manifold (9) and the cylinder head (2) of an internal combustion engine (100) is held together at one side of a cross-section of an inlet passage (12) extending through the flange connection (20) by a first screw connection (20), and
the cooler housing (5) includes a second support part (72) for mounting the charge fluid cooler (1) by means of a second screw connection (60) to a cylinder block (3) of an internal combustion engine (100), wherein by means of the second support part (72) a support structure is formed for the charge fluid cooler (1) at the second screw connection (60),
the support opening (31) being arranged at the cooler housing (5) so as to form an accommodation space (A) to the manifold side flange connecting surface (20.1) wherein the length of the accommodation space A is greater than the length (B) of the support opening (31) and
the accommodation space (A) is provided for accommodating a spacer sleeve (34) serving the first screw connection (30), and wherein
the support formed by the second support part (72) is a part-side rigid and a part-side elastic support member for disposition between the second support part (72) and the second screw connection (60).
